(19) United States
(12) Patent Application Publication
(10) Pub. No.: US 2017/0263946 A1
(43) Pub. Date: Sep. 14, 2017

(54) CARBON-BASED NANOSTRUCTURE MEMBRANES

(71) Applicant: The Penn State Research Foundation, University Park, PA (US)

(72) Inventor: Kofi W. Adu, State College, PA (US)

(21) Appl. No.: 15/529,868

(22) PCT Filed: Nov. 25, 2015
(86) PCT No.: PCT/US2015/062714

§ 371 Date: May 25, 2017

Related U.S. Application Data
(60) Provisional application No. 62/084,317, filed on Nov. 25, 2014.

(51) Int. Cl. H01M 4/96; H01M 4/66; H01M 4/583; H01B 1/04; H01G 11/36

(52) U.S. Cl. CPC H01M 4/96; H01B 1/04; H01G 11/36; H01M 4/583; C01B 31/0253; H01M 4/663

(57) ABSTRACT

The disclosure features methods for preparing a carbon nanostructure-based membranes, the methods including initiating self-assembly of a plurality of carbon nanostructures by suspending the nanostructures in a liquid where the liquid has a density that exceeds a density of the nanostructures, forming a membrane on a surface by removing the liquid, thereby depositing the nanostructures on the surface, and heating the membrane in a vessel that includes hydrogen gas.

### CROSS-REFERENCE TO RELATED APPLICATIONS

This application claims priority to U.S. Provisional Patent Application No. 62/084,317, filed on Nov. 25, 2014, the entire contents of which are incorporated herein by reference.

### TECHNICAL FIELD

This disclosure relates to membranes formed of carbon nanostructures, including all forms of carbon nanotubes (single walled carbon nanotubes, double walled carbon nanotubes, and more generally, multi-walled carbon nanotubes), carbon nanohorns, carbon nanofibers, graphene, carbon nanoparticles and combinations thereof.

### BACKGROUND

Carbon nanostructures (CNs) such as carbon nanotubes have a number of advantageous properties, including high mechanical strength, electrical conductivity, high surface area, and chemical functionalizability. To take advantage of these properties, carbon nanostructures can be incorporated into thin sheets (e.g., “Buckypaper”) which facilitates handling for a variety of applications. Buckypaper is typically fabricated by filtration or forming an aggregate of carbon nanotubes and a binder material into a mat.

### SUMMARY

Disclosed herein are membranes formed from carbon nanostructures (CNs), including all forms of carbon nanotubes (CNTs) (e.g., single walled carbon nanotubes (SWCNTs), double walled carbon nanotubes (DWCNTs), and more generally, multi-walled carbon nanotubes (MWCNTs)), carbon nanofibers (CNFs), graphene, carbon nanohorns (CNHs), carbon nanoparticles (CNPs), and combinations of such nanostructures. The membranes typically do not include binder materials or other constituents that interfere with the physical and/or chemical properties of the carbon nanostructures. As such, the membranes substantially preserve the properties of the nanostructures that are advantageous for many applications, including electrical conductivity and mechanical strength. As a result, the membranes can be used in a variety of applications, including as electrodes in energy storage and conversion systems (e.g., advanced batteries, supercapacitors, and fuel cells), in sensors, in actuators, in photovoltaic cells, and in thermoelectric devices. The fabrication methods disclosed herein permit membranes having a wide variety of shapes and thicknesses to be prepared.

In general, in a first aspect, the disclosure features methods for preparing a carbon nanostructure membrane, the methods including: initiating self-assembly of a plurality of carbon nanostructures by suspending the nanostructures in a liquid, where the liquid has a density that exceeds a density of the nanostructures; forming a membrane on a surface by removing the liquid, thereby depositing the nanostructures on the surface; and heating the membrane in a vessel that includes hydrogen gas.

Embodiments of the methods can include any one or more of the following features.

The liquid can include bromine. A density of the liquid can be between 1.3 g/cm³ and 3.5 g/cm³. The liquid can have an electron affinity of −100 kJ/mol or more.

The methods can include removing the liquid by heating the liquid. The liquid can have a boiling point temperature at atmospheric pressure of 244° C. or less.

The surface can be a surface of the vessel. The surface can be formed of at least one metal selected from the group consisting of platinum, gold, silver, aluminum, and copper.

Heating the membrane can include heating the membrane to a temperature of 1000° C. or more (e.g., a temperature of 1200° C. or more). A concentration of hydrogen gas in the vessel can be 1% or more (e.g., 5% or more).

The methods can include continuing the heating until a concentration of the liquid and/or impurities in the membrane is less than 1000 ppm.

Embodiments of the methods can also include any of the other steps or features disclosed herein, in any combination, as appropriate.

In another aspect, the disclosure features binder-free membranes that include a plurality of carbon nanostructures arranged to form a substantially planar layer, where an average density of the carbon nanostructures in the membrane is 0.5 g/cm³ or more.

Embodiments of the membranes can include any one or more of the following features.

An electrical conductivity of the membrane can be 1.0×10⁴ S/m or more. A Young's modulus of elasticity of the membrane can be 0.01 GPa or more. An in-plane thermal conductivity of the membrane can be 250 W/m·K or more, and an out-of-plane thermal conductivity of the membrane can be 0.5 W/m·K or more. A contact angle of a water droplet on a surface of the membrane can be 175° or less.

The carbon nanostructures can include at least one dopant. The at least one dopant can include a material selected from the group consisting of nitrogen and boron.

The carbon nanostructures can include at least one metallic material. The at least one metallic material can include one or more transition metals, such as a material selected from the group consisting of Pt, V, Ti, Ru, Cr, Mn, Mo, Co, Fe, Pd, and Os.

The membranes can include a support layer on which the membrane is positioned. The support layer can include at least one metallic material. The at least one metallic material can be selected from the group consisting of platinum, gold, silver, aluminum, and copper. The support layer can include one or more layers of grafoil and/or one or more layers of graphene, e.g., graphene sheets. The support layer can include at least one polymer material. The at least one polymer material can be selected from the group consisting of polycarbonates, polypropylenes, polyethylenes, polyvinyls, polyacrylates, polystyrenes, and polymethylmethacrylates. The support layer can include at least one transition metal dichalcogenide material.

The carbon nanostructures can include carbon nanoparticles. The carbon nanostructures can include carbon nanofibers. The carbon nanostructures can include graphene. The carbon nanostructures can include carbon nanotubes. The carbon nanotubes can include single walled carbon nanotubes. The carbon nanotubes can include multi-walled carbon nanotubes. The carbon nanostructures can include carbon nanohorns.

The carbon nanostructures can include a mixture of carbon nanoparticles and carbon nanotubes. The carbon nanostructures can include a mixture of carbon nanofibers and carbon nanotubes. The carbon nanostructures can include a mixture of carbon nanofibers and graphene. The carbon nanostructures can include a mixture of graphene and carbon nanotubes.

Embodiments of the membranes can also include any of the other features disclosed herein, in any combination, as appropriate.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the subject matter herein, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments are set forth in the accompanying drawings and the description below. Other features and advantages will be apparent from the description, drawings, and claims.

### DESCRIPTION OF DRAWINGS

FIG. 1 is a flow chart showing a series of steps for fabricating carbon nanostructure (CN)-based membranes.

FIGS. 2A-2C are sets of images showing fabricated CN-based membranes.

FIG. 2D is a scanning electron microscope (SEM) image of a CN-based membrane.

FIG. 2E is a filtered version of the image of FIG. 2D.

FIG. 2F is a histogram showing the statistical distribution of voids in a CN-based membrane.

FIG. 2G is an SEM image of a broken edge of a CN-based membrane.

FIG. 2H is a cross-sectional SEM image of a piece of a CN-based membrane.

FIG. 2I is a cross-sectional SEM image of a piece of CN-based membrane coated with a transition metal dichalcogenide (TMD) material.

FIGS. 3A-3C are plots showing 3D, 2D, and line profiles of a piece of CN-based membrane.

FIG. 3D is a plot showing the variation of CN mass versus membrane thickness.

FIG. 3E is a plot showing optical profilometer measurements for a CN-based membrane.

FIG. 3F is an image of a piece of CN-based membrane in water.

FIG. 4A is a plot showing Raman scattering measurements for single-walled carbon nanotubes (CNTs) in power form and in a membrane.

FIG. 4B is a plot showing thermogravimetric analysis weight loss as a function of temperature for a CN-based membrane.

FIG. 4C is a plot showing EDS spectra of the as-received CNTs and a CNT-based membrane.

FIG. 5A is a plot showing nitrogen adsorption and desorption isotherms for CNT powder and a CNT-based membrane as a function of relative gas pressure.

FIG. 5B is a plot showing BET isotherms for CNT power and a CNT-based membrane.

FIG. 5C is a plot showing cumulative pore volume differential pore volume for CNT powder and a CNT-based membrane.

FIGS. 6A and 6B are plots showing electron energy loss spectra for boron-doped single-walled CNTs at different dopant concentrations.

FIG. 7A is a plot showing cyclic voltammograms measured at different scan rates for a capacitor that includes a CNT-based membrane.

FIG. 7B is a plot showing charge-discharge response curves for the capacitor of FIG. 7A.

FIG. 7C is a plot showing impedance curves for a capacitor based on single-walled CNTs and for other commercial capacitors.

FIG. 7D is a plot showing impedance curves for capacitors that include a CNT-based membrane with different electrolyte concentrations.

FIG. 7E is a plot showing a cyclic voltammograms of a two electrode capacitor formed from a CNT-based membrane.

FIG. 7F is a plot showing specific capacitance as a function of scan rate for the capacitor of FIG. 7E.

FIG. 7G is a plot showing the constant current charge/discharge response of the capacitor of FIG. 7E.

FIG. 7H is a plot showing specific capacitance as a function of number of cycles for the capacitor of FIG. 7E.

FIGS. 8A and 8B are Nyquist and Bode plots, respectively, for a CNT membrane-based capacitor in a 1 M aqueous sulfuric acid electrolyte.

FIG. 8C is a plot showing capacitance as a function of frequency for the capacitor of FIGS. 8A and 8B.

FIG. 8D is a plot showing the relaxation frequency for the capacitor of FIGS. 8A and 8B.

FIG. 9A is a schematic diagram of a flexible, solid state supercapacitor that includes multiple CN-based membranes.

FIG. 9B is an image of the solid state supercapacitor of FIG. 9A.

FIG. 9C is a plot showing cyclic voltammograms measured for the solid state supercapacitor of FIG. 9A.

FIG. 9D is a cross-sectional SEM image of a flexible solid state super supercapacitor.

FIG. 9E is a plot showing specific capacitance measurements for the supercapacitor of FIG. 9A as a function of temperature.

Like reference symbols in the various drawings indicate like elements.

### DETAILED DESCRIPTION

Carbon nanostructure-based membranes are useful in a wide variety of applications, including CO₂ sequestration, biofuel purification, controlled oxidation, hydrogen purification and separation, and catalysis. Further, carbon nanostructures (CNs) can be used in electrodes and/or catalyst supports in photovoltaic, thermoelectric, and electrochemical energy storage devices and conversion systems. Various CNs, such as CNTs for example, have properties that make them well suited for such applications. For example, CNTs typically have high electrical conductivity (e.g., between 10 and 30 kS/cm), high thermal conductivity (e.g., approximately 1500-6000 W/m·K), undergo room temperature ballistic transport, are stable at moderate temperatures, are relatively lightweight and low density, and have high aspect ratios and high surface areas with no bulk atoms (e.g., all atoms are surface atoms).

However, conventional approaches to preparing CN-based functional layers—including in situ assembly methods on supporting substrates, and post-synthesis processing of CNs into membranes—often yield products for which the physical and/or chemical properties are compromised relative to CNs. Furthermore, the presence of other materials in the products, such as binder materials in “Bucky paper” formed of CNs, also compromises the properties of the products.

Some conventional methods functionalize CNs with undesirable species, suppress intrinsic properties of CNs, and/or damage CN structures. Certain conventional methods yield CN-based layers with low packing densities and/or with undesirable species (e.g., growth catalysts and/or carbonaceous impurities) incorporated therein. Such layers tend to be fragile and to deteriorate easily as a result of swelling and other mechanical perturbations. In addition, many conventional methods for preparing CN-based layers are not suited to scaling up for large volume production.

Conventional solid state methods for producing CN layers typically use mechanical pressure to roll CNs into a mat. As a result, the mats degrade relatively quickly when exposed to exterior mechanical forces. CN electrodes produced in this manner generally include at least one binder material such as polyaniline chloride and/or a conductive epoxy. These binder materials reduce the overall effective surface area of the CN electrode and add weight to the electrode, both of which result in poorer application performance.

Conventional liquid phase methods for producing CN layers typically yield mats with relatively low CN packing density, and which are susceptible to shrinkage when heated. In some liquid phase methods, high concentrations of acids such as sulfuric acid, nitric acid, and/or super acid are used to prepare mats that have a tendency to be brittle or fragile with poor mechanical properties. In some methods, liquids such as water, ethanol, and/or acetone can be used to collapse “forests” of CNs (e.g., grown on a Cu or Pt substrate) into mats after formation. Further, conventional liquid phase methods typically product CN mats of only a few millimeters in size.

The methods disclosed herein provide improved techniques for preparing CN-based membranes. The membranes produced are flexible, robust, and free of binder materials. In addition, large-area membranes can be prepared in a process that is scalable for purposes of large volume production. The membranes largely retain the intrinsic properties of individual CNs, and therefore possess most or all of the properties of CNs that are desirable for a wide variety of applications. Moreover, the methods can be used with a wide variety of substrates, and even with no substrate at all.

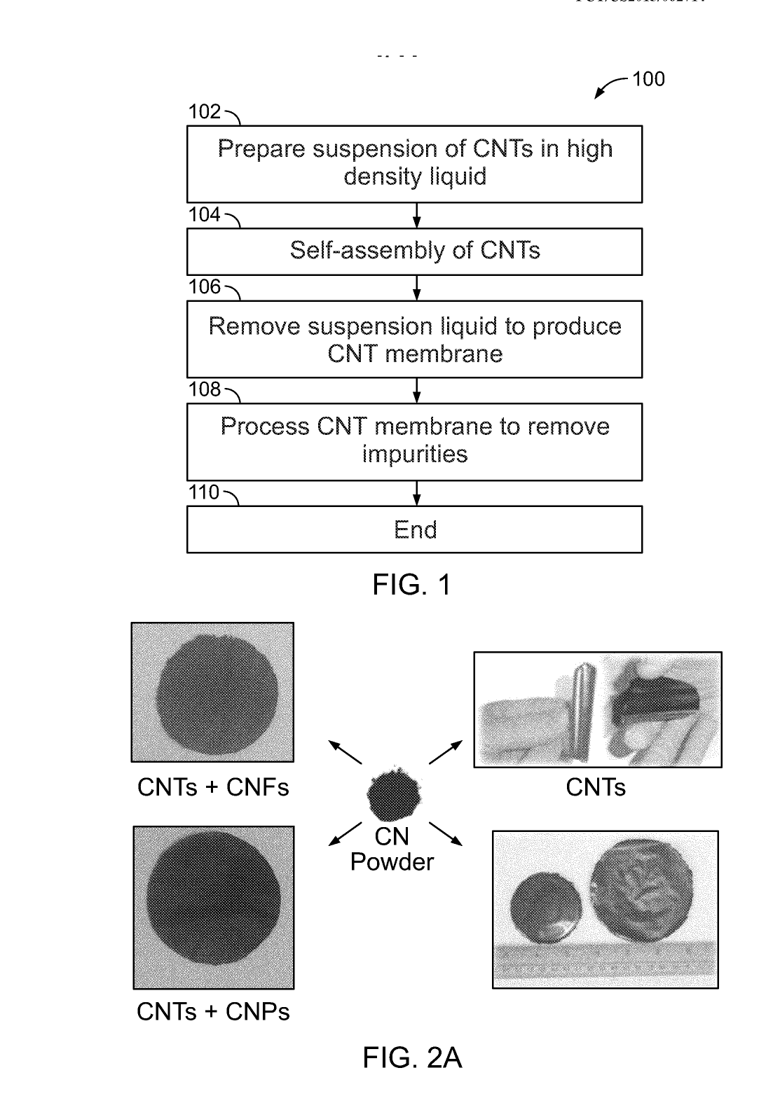

FIG. 1 is a flow chart 100 that shows a series of steps for preparing a CN-based membrane using a liquid phase post-synthesis self-assembly technique. In the first step 102, a suspension of CNs (e.g., single-walled CNTs) is prepared in a high density liquid. CNs can be obtained from a variety of sources, including for example: Thomas Swan & Co., Consett, UK; Aldrich Chemicals, St. Louis, Mo.; Carbon Solution, Inc., Riverside, Calif.; and Graphene Laboratories, Inc., Calverton, N.Y. In general, the CNs used can include carbon nanotubes (single-walled CNTs, multiple-walled CNTs, and/or mixtures of single-walled and multiple-walled CNTs), graphene, carbon nanofibers, carbon nanohorns, carbon nanoparticles, and mixtures of the foregoing compounds.

In some embodiments, the CNs such as CNTs that are used to prepare membranes are un-functionalized. In certain embodiments, the CNs can be functionalized. Mixtures of un-functionalized and functionalized CNs can also be used to prepare membranes. In general, functionalized CNs can include CNs to which a variety of different chemical functional groups have been chemically bonded. Suitable chemical functional groups include inorganic and organic groups such as halide substituents, alkyl groups, acid groups, ester groups, aldehyde groups, aromatic groups, amine groups, polyaromatic hydrocarbon groups, and further substituted examples of any of the foregoing groups.

In assembling the CNs into functional macro-sized materials from the liquid phase, one has to consider the physicochemical properties of the CNs in relation to the properties of the liquid. CNs such as CNTs are mostly bundled due to van der Waals' interactive forces (e.g., about 0.5 eV/nm). CNs exist generally in metallic or semiconducting states with broad distributions of diameters, lengths, and electronic properties. They typically have high aspect ratios (e.g., greater than or equal to 10⁷) and true densities between 1.3 g/cm³ and 2.6 g/cm³. Accordingly, liquids used to suspend the CNs are generally chosen such that they reduce van der Waals interactions among the CNs, prevent agglomeration, and facilitate self-assembly of the CNs into densely packed, uniformly distributed, macrostructural membranes.

Accordingly, the liquid chosen to suspend the CNs strongly influences the quality (e.g., the uniformity and the physical and chemical properties) of the membrane that is produced. In general the liquid used to suspend the CNs has a bulk density that is larger than the CNs so that once suspended, the CNs float on or near the surface of the liquid.

Conventional methods for liquid phase preparation of CN mats tend to yield mats in which the CN density varies significantly from one region to the next within the mat due to agglomeration of the CNs. Without wishing to be bound by theory, it is believed that by using a high density liquid to suspend the CNs, interactions between the CNs are disrupted by the liquid, reducing the tendency of the CNs to agglomerate. As a result, membranes formed using the methods disclosed herein have a significantly more uniform distribution of CNs throughout, and thus have physical and chemical properties that are more uniform across the surface of the membrane.

As discussed above, the bulk density of the liquid used to suspend the CNs is relatively high, and higher than the density of the CNs. In some embodiments, for example, the bulk density of the liquid is 1.3 g/cm³ or more (e.g., 1.5 g/cm³ or more, 2.0 g/cm³ or more, 2.5 g/cm³ or more, 3.0 g/cm³ or more, 3.5 g/cm³ or more). In general, as the density of the liquid increases, the number of different types of CN-based membranes that can be prepared using the methods disclosed herein increases.

The liquid chosen to suspend the CNs also generally is capable of transferring charges to the CNs (e.g., a charge transfer induced heavy liquid). Without wishing to be bound by theory, it is believed that the transfer of charges assists with self-assembly of the CNTs on the surface of the liquid into a layer that is suitable for forming a membrane. Heavy liquids suitable for the fabrication of the CN membranes disclosed herein include, for example, Cargille Heavy Liquids (available from Cargille Laboratories, Cedar Grove, N.J.).

Aqueous acid solutions are capable of transferring charges (e.g., protons) to CNs to aid in self-assembly. However, it has been observed that in some embodiments, the use of acids can chemically degrade the properties of CNs. Accordingly, in certain embodiments, aprotic liquids are used to suspend the CNs and provide for charge transfer to the CNs. The aprotic liquids can have an electron affinity of −100 kJ/mol or more (e.g., −150 kJ/mol or more, −200 kJ/mol or more, −250 kJ/mol or more, −300 kJ/mol or more, −300 kJ/mol or more, −400 kJ/mol or more)

Because the liquid transfers charges to the CNs, the liquid used to suspend the CNs typically has a relatively low ionization energy. For example, in some embodiments, the ionization energy of the liquid is 1700 kJ/mol or less (e.g., 1600 kJ/mol or less, 1500 kJ/mol or less, 1400 kJ/mol or less, 1200 kJ/mol or less, 1000 kJ/mol or less).

A variety of different liquids and/or solids can be used to suspend the CNs. In some embodiments, for example, liquid and/or solid halides (e.g., bromine and iodine) can be used, as they have relatively high density and are capable of transferring charges to CNs. Other liquids can also be used including, for example, organic liquids including halogenated organic liquids such as thenyl, acetylene tetrabromide, and diiodomethane. The CNs can also be suspended in mixtures of any of the liquids and/or solids disclosed herein.

Next, in step 104, the CNs self-assemble on the surface of the suspending liquid. Self-assembly is generally rapid and is completed after a relatively short period of time. Prior to self-assembly, the liquid and suspended CNs can be transferred to a vessel for preparation of the membrane, such as a Petri dish, so that the liquid remains undisturbed during self-assembly of the CNs. In general, the period during which self-assembly occurs is generally between a few minutes (e.g., 2 minutes or more, 4 minutes or more, 6 minutes or more, 8 minutes or more, 10 minutes or more, 30 minutes or more, 60 minutes or more, 2 hours or more, 3 hours or more) and 48 hours (e.g., 46 hours or less, 44 hours or less, 40 hours or less, 30 hours or less, 20 hours or less, 10 hours or less, 5 hours or less).

In step 106, the suspending liquid is removed to produce the CN membrane. Removal of the liquid is typically performed by applying gentle heat to the vessel that contains the liquid. Heating the liquid in this manner causes it to evaporate, leaving behind a membrane formed only by CNs. In some embodiments, for example, the liquid is heated to a temperature of 150° C. or less to cause evaporation. Without wishing to be bound by theory, it is believed that as the suspending liquid is removed, van der Waals' forces between individual CNs increase, and the CNs therefore remain in their self-assembled positions without forming agglomerates. As a result, the distribution of CNs within the membrane remains relatively uniform, and holes due to agglomeration are avoided.

In some embodiments, the vessel is connected to a trap (e.g., a cryogenic trap) so that the evaporated liquid can be collected. Collection of the liquid renders the overall process cleaner, producing less waste. The overall process can also be rendered more economical because the collected liquid can be recycled and used for the fabrication of subsequent membranes.

Typically, to aid in evaporation, the liquid used to suspend the CNs has a relatively low boiling point at atmospheric pressure. In some embodiments, for example, the liquid has a boiling point of 244° C. or less (e.g., 240° C. or less, 220° C. or less, 200° C. or less, 180° C. or less, 160° C. or less, 140° C. or less, 120° C. or less).

In certain embodiment, to assist in the removal of the liquid, evaporation can be performed under reduced pressure, which lowers the boiling temperature of the liquid. For example, removal of the liquid can occur at pressures of 1 atm or less (e.g., 0.8 atm or less, 0.6 atm or less, 0.4 atm or less, 0.2 atm or less, 0.1 atm or less).

Removal of the suspending liquid leads to formation of a membrane on the bottom of the vessel. The membrane is formed entirely of CNs, and does not include binding or other chemical agents. Moreover, concentrations of impurities within the membrane are generally very low. The presence of impurities in the product membrane can generally be controlled by using CNs of sufficient purity and a liquid of sufficient purity in step 102.

In optional step 108, the membrane is further processed to remove impurities. At this stage, impurities can include residual liquid as well as other foreign substances (e.g., substances that are not CNs). Removal of the impurities is typically performed by heating the membrane to a high temperature, such as 400° C. or more (e.g., 500° C. or more, 600° C. or more, 700° C. or more, 800° C. or more, 900° C. or more, 1000° C. or more, 1100° C. or more, 1200° C. or more, 1300° C. or more, 1400° C. or more).

In some embodiments, the membrane can be heated in a hydrogen-rich environment to remove residual liquid from the membrane. Without wishing to be bound by theory, it is believed that for certain liquids, heating in a hydrogen-rich environment converts the liquid to a substance that can be more easily removed by evaporation. For example, when the suspending liquid is bromine, treatment with hydrogen gas converts the liquid to HBr, which is then removed by heating the membrane. In some embodiments, for example, the membrane is heated in a hydrogen-rich environment of 95% Ar and 5% Hz. More generally, the concentration of hydrogen in the hydrogen-rich environment can be varied according to the concentration of impurities in the membrane for example. The hydrogen concentration can be, for example, between 1% and 100% (e.g., between 20% and 90%, between 30% and 80%, between 40% and 60%). In some embodiments, the hydrogen concentration is larger than 1% (e.g., larger than 10%, larger than 20%, larger than 30%, larger than 40%, larger than 50%, larger than 60%, larger than 70%, larger than 80%, larger than 90%).

Other processing steps can also be performed to remove different types of impurities. For example, in some embodiments, the membrane can be heated in the presence of chlorine gas to remove metal particles from the membrane. Without wishing to be bound by theory, it is believed that such treatment converts residual metal particles to metal chlorides, which can then be evaporated out of the membrane. Typically, the heating occurs in a chlorine-rich environment, with chlorine concentrations similar to those discussed above for hydrogen. Further, the temperature to which the membrane is heated is similar to the temperatures discussed above that are used to remove residual liquid from the membrane.

In some embodiments, the membrane is further exposed at high temperatures to low concentrations of sulfur. While not wishing to be bound by theory, it is believed that the sulfur cross-links the CNs, yielding a mechanically stronger membrane. In particular, when the CNs include CNTs, sulfur treatment vulcanizes the cross-over junctions of the CNTs. In general, sulfur treatment is performed at high temperatures that are similar to the temperatures disclosed in connection with step 108 above. Sulfur treatment can be performed at the same time as step 108, or before or after step 108 as a separate step.

At the completion of step 108, the concentration of the suspending liquid in the membrane and/or the concentration of other impurities is generally extremely low. In some embodiments, for example, the concentration of the liquid and/or other impurities is less than 1000 ppm (e.g., less than 500 ppm, less than 300 ppm, less than 200 ppm, less than 100 ppm, less than 50 ppm, less than 25 ppm). Such impurity concentrations are low compared to many conventional fabrication methods, which can leave behind a variety of different chemical impurities in a CN-based mat. In particular, many such methods use a significant number of chemical steps, each of which leaves behind a residual concentration of impurities. These impurities can interfere with the adherence of the CNs to one another. After removal of impurities in step 108, the procedure finishes at step 110.

The methods discussed herein can be used to form CN-based membranes that have a wide variety of shapes. In general, the shape of the membrane is controlled to a significant extent by the shape of the vessel. Thus, membranes can be formed in a variety of regular and irregular shapes, including circular membranes, square membranes, rectangular membranes, and membranes formed as n-sided polygons (where n is an integer larger than 2).

The overall size of the membrane and its thickness are generally a function of the dimensions of the vessel and the concentration of CNs suspended in the liquid. Increasing the concentration of CNs enables the formation of larger and thicker membranes. In some embodiments, very large membranes can be produced. For example, membranes can be produced for which a maximum dimension of the membrane (e.g., the largest distance between any two points on the surface of the membrane) is 2 inches or more (e.g., 3 inches or more, 4 inches or more, 6 inches or more, 8 inches or more, 10 inches or more, 12 inches or more, 16 inches or more).

As mentioned above, the thickness of the CN-based membrane is a function of the concentration of the CNs. In certain embodiments, the membranes produced have a thickness of 1 millimeter or less (e.g., 750 microns or less, 500 microns or less, 300 microns or less, 200 microns or less, 100 microns or less, 75 microns or less, 50 microns or less, 40 microns or less, 30 microns or less, 20 microns or less, 10 microns or less, 7 microns or less, 5 microns or less). It has been observed that even relatively thin membranes with thicknesses of approximately 10 microns retain the mechanical properties associated with individual CNs. Moreover, many applications significantly benefit from relatively thin membranes. For example, using such thin membranes in batteries provides for increased power density and reduced weight relative to conventional electrode materials.

As discussed above, the methods disclosed herein yield membranes in which CNs are packed densely and relatively uniformly throughout the membrane due to the effect of the suspending liquid. This is in sharp contrast to many conventional fabrication methods, where the CN density is smaller, and where agglomeration leads to uneven packing within the membrane.

Membranes can be produced using the methods disclosed herein that have an average CN density that can be tuned from 0.5 g/cm³ to 2.2 g/cm³ (e.g., a CN density of 0.6 g/cm³ or more, of 0.7 g/cm³ or more, of 0.8 g/cm³ or more, of 0.9 g/cm³ or more, of 1.0 g/cm³ or more, of 1.1 g/cm³ or more, of 1.3 g/cm³ or more, of 1.5 g/cm³ or more, of 1.7 g/cm³ or more, of 1.9 g/cm³ or more, of 2.1 g/cm³ or more). Due to the very high packing densities of CNs in the membranes, there is limited or no variation in density within a membrane. Within the membrane, the CN density varies from one location to another by 20% or less (e.g., 15% or less, 10% or less, 7% or less, 5% or less, 3% or less, 1% or less).

Membrane densities can be measured with a gas pycnometer calibrated with a suitable standard material (e.g., steel). Alternatively, membrane densities can be measured using optical profilometry. In optical profilometry, a thickness of a membrane (or a portion of a membrane) is measured, and the dimensions of the membrane (or portion thereof) are used with the thickness measurement to determine the volume. The mass of the membrane is determined using an analytical balance, and the density is then calculated from the volume and mass.

The absence of binders and impurities in the membranes produced using the methods disclosed herein also preserves the advantageous electrical and mechanical properties of CNs in the membranes. Many conventional fabrication methods yield CN-based mats for which thermal and electrical properties are not as good as for isolated CNs due to the presence of binder materials in the membranes, which reduces the density of packing of the CNs. Further, in many conventional methods, Li ions (and other ions) used in the fabrication process penetrate into micropores formed in the sidewalls of the CNs. When a voltage is applied across such a mat, the Li ions (and other such impurity ions) are liberated. The motion of the ions causes swelling of the mat, weakening it as time goes on. The embedded ions also create small electrodes within the mat, which reduces its electrical performance in a variety of different applications.

The membranes produced using the methods disclosed herein are not compromised in this manner because binder materials are not used, and the concentrations of impurities such as ionic impurities are very low. As a result, the membranes have significantly improved electrical and mechanical properties. Furthermore, the reproducibility of these properties in the membranes produced using the methods disclosed herein are significantly higher than in mats produced using many conventional methods.

In some embodiments, for example, the membranes produced using the methods disclosed herein have an electrical conductivity of 1.0×10⁴ S/m or more (e.g., 1.0×10⁵ S/m or more, 1.0×10⁶ S/m or more, 1.0×10⁷ S/m or more, 1.0×10⁸ S/m or more, 1.0×10⁹ S/m or more, 1.0×10¹⁰ S/m or more). Electrical conductivity can be measured, for example, in a four-probe van der Pauw geometry by electrically contacting four corners of a membrane, applying an excitation current through two of the four electrical contacts, and measuring the voltage across the other two electrical contacts (e.g., the two voltage lead wires) using a voltmeter (e.g., a Keithley nanovoltmeter). The conductivity is then determined from the measured voltages.

In certain embodiments, the membranes have an in-plane thermal conductivity of 250 W/m·K or more (e.g., 500 W/m·K or more, 1000 W/m·K or more, 1500 W/m·K or more, 2000 W/m·K or more, 2500 W/m·K or more, 3000 W/m·K or more, 3500 W/m·K or more, 4000 W/m·K or more, 4500 W/m·K or more, 5000 W/m·K or more, 5500 W/m·K or more). In some embodiments, the membranes have an out-of-plane thermal conductivity of 0.5 W/m·K or more (e.g., 1.0 W/m·K or more, 5.0 W/m·K or more, 10.0 W/m·K or more, 20.0 W/m·K or more, 30.0 W/m·K or more, 50.0 W/m·K or more, 70.0 W/m·K or more, 100.0 W/m·K or more). The in-plane and out-of-plane thermal conductivities can be measured, for example, using a laser flash thermal conductivity measurement system.

In some embodiments, the membranes produced using the methods disclosed herein have relatively high tensile strength compared to CNT-based mats produced using conventional methods due to the close packing of CNTs within the membrane and the absence of binder materials in the membrane. For example, membranes produced using the methods disclosed herein can have a Young's modulus of elasticity of 0.01 GPa or more (e.g., 0.1 GPa or more, 0.5 GPa or more, 1.0 GPa or more, 2.0 GPa or more, 3.0 GPa or more, 5.0 GPa or more, 7.5 GPa or more, 10.0 GPa or more). The modulus of elasticity can be measured using a dynamic mechanical analyzer (DMA) or an Instron micro-mechanical tester attachment.

Due to the relatively high density of CNs and low concentrations of impurities in the membranes produced using the methods disclosed herein, the surface wetting properties of the membranes can differ markedly from CN-based mats produced using conventional fabrication methods. In particular, membranes produced using the methods disclosed herein can have increased wettability. For example, the contact angle for a water droplet on the surface of a membrane produced as disclosed herein can be 175° or less (e.g., 170° or less, 160° or less, 150° or less, 140° or less, 120° or less, 100° or less, 80° or less, 70° or less, 60° or less, 55° or less). The contact angle can be measuring using a commercial optical contact angle measurement system.

The methods disclosed herein can generally be used to form CN-based membranes on a variety of surfaces. In the discussion of FIG. 1 above, the membrane was formed on the surface of a vessel such as a Petri dish. More generally, however, the methods can be used to form membranes on a variety of surfaces. In some embodiments, for example, membranes can be prepared on metal surfaces (e.g., electrodes) formed from materials such as platinum, gold, silver, aluminum, and copper. When the methods are used to prepare a membrane on a metal surface, the suspending liquid is chosen so that it does not substantially react chemically with the material of the metal surface.

Membranes can also be formed on other surfaces. For example, membranes can be prepared on surfaces formed of a variety of plastic materials such as polycarbonates, polypropylenes, polyethylenes, polyvinyls, and polyacrylates. Membranes can be formed on a variety of softer materials such as polystyrenes and polymethylmethacrylates. Membranes can also be formed on surfaces that include one or more layers of materials such as grafoil and/or graphene.

As discussed above, a variety of different CNs can be used to prepare membranes using the methods disclosed herein. CNs that are modified (e.g., via chemical functionalization or doping) can be modified prior to assembly into a membrane, or following assembly. In some embodiments, CNs are modified by introducing dopants into the nanotube structures. Dopants can be used, for example, to control the chemical reactivity of the CNs and/or to adjust the electrical and/or mechanical properties of the CNs. Dopants that can be introduced include, for example, nitrogen, boron, and a variety of metals (e.g., transition metals) that can be used for catalytic applications such as Pt, V, Ti, Ru, Cr, Mn, Mo, Co, Fe, Pd, and Os. Multiple dopant materials can be introduced into a single membrane if desired (e.g., for a particular application). Other metals and metal-based moieties (such as complexed transition metals) can also be introduced. Additionally, other non-metallic elements can be introduced into the membranes, including elements such as B, N, and P.

In certain embodiments, CNs are modified by chemically functionalizing the CNs. Chemical functionalization can be used to control the electrical and/or mechanical properties of the CNs and also to introduce a variety of different chemically reactive entities or groups, or functional chemical units, into the nano-structures. Functional groups that can be introduced into the structures of the CNs can include, for example, inorganic and organic groups such as halide substituents, alkyl groups, acid groups, ester groups, aldehyde groups, aromatic groups, amine groups, polyaromatic hydrocarbon groups, and further substituted examples of any of the foregoing groups.

Due to their high CN packing densities, membranes produced according to the methods disclosed herein can include higher concentrations of dopants and chemical functional groups than mats produced using other methods. In some embodiments, for example, the dopant concentration in a membrane is 50 ppm or more (e.g., 100 ppm or more, 200 ppm or more, 300 ppm or more, 500 ppm or more, 600 ppm or more, 800 ppm or more, 1000 ppm or more). In certain embodiments, the membranes are doped to 0.01 wt % or more (e.g., 0.1 wt % or more, 0.5 wt % or more, 1.0 wt % or more, 2.0 wt % or more, 3.0 wt % or more, 5.0 wt % or more, 10.0 wt % or more, 20.0 wt % or more, 30.0 wt % or more). In certain embodiments, the concentration of chemical functional groups introduced through functionalization is 10 ppm or more (e.g., 20 ppm or more, 30 ppm or more, 50 ppm or more, 100 ppm or more, 200 ppm or more, 300 ppm or more, 500 ppm or more, 600 ppm or more, 800 ppm or more, 1000 ppm or more).

Due to the various properties discussed above, the membranes disclosed herein are particularly well suited for applications in energy storage and conversion systems. The membranes are capable of supporting extremely high power densities of 1200 kW/kg or more due to their electrical and mechanical properties. In addition, the membranes demonstrate high cyclability, and are typically capable of more than 100,000 cycles before their properties show marked deterioration (e.g., before their electrical conductivity properties degrade by more than 10%). The membranes also demonstrate high temperature stability between 20° C. and 100° C., resisting degradation of their electrical conductivity properties between these temperature limits. The membranes remain flexible, lightweight, capable of supporting energy densities of more than 12 F/g, and can be incorporated into flexible bipolar stacks supporting voltages of between 1 V and 1000 V.

In addition to membranes formed from CNTs, the methods disclosed herein can be used to fabricate membranes from other carbon-based nanostructures, include graphene, nanofibers, nanoparticles, nanohorns, and combinations of these.

### EXAMPLES

The subject matter disclosed herein is further described in the following examples, which are not intended to limit the scope of the claims.

To demonstrate the effectiveness of the methods disclosed herein, CN-based membranes were prepared using CNs from a variety of different sources. As an example, to prepare CN membranes, commercial CNTs (Thomas Swan Elicarb CNTs, obtained from Thomas Swan & Co., Consett, UK) of nominal residual content ˜3.5 wt % were dispersed and suspended in a high-density liquid (Cargille Heavy Liquid) under continuous magnetic stirring. The liquid was thermally evaporated slowly and trapped cryogenically, resulting in the formation of the binder-free CNT membrane. The mass of the CNTs was varied within the range 30 mg to 150 mg in a fixed volume of the liquid (10 cm³) and assembled in a 52.0 mm diameter container. To fabricate the membranes, 30 mg of the CNT was suspended in 10 cm³ of the heavy liquid under continuous magnetic stirring at 600 rpm for several hours. The suspension was transferred into the 52.0 mm diameter glass container that was placed in a sealed, thermally controlled environment. The liquid was thermally evaporated slowly and cryogenically trapped, leaving the CNTs in the form of a densely packed membrane. Membranes with other CNT concentrations, e.g., 60 mg, 90 mg, 120 mg and 150 mg, were prepared under similar conditions. The membranes were purified using chlorine gas.

A chlorination protocol was used to digest and extract residual contaminants in the membranes. Most contaminants were residual metal catalyst, amorphous carbon and silica from the synthesis precursors and the supporting substrate. The membranes were placed inside a two-inch diameter quartz tube mounted in a Thermolyne 21100 horizontal tube furnace. The system was purged with helium at 200 sccm for an hour and then heated to 900° C. at 50° C./min. The gas was switched to a mixture of helium/chlorine (95%:5%), and purification continued for one hour. This was followed by similar ratio of helium/hydrogen (95%:5%) for 4 hours. The system was finally purged at the same temperature under the helium environment for one hour and then cooled down to room temperature.

Temperature programmed oxidation (TPO) on TA Q5000IR thermogravimetric analyzer (TGA) was used to analyze the ash content of the original Thomas Swan Elicarb CNT powder and the purified CNT membrane. The TPO of 5 mg of the commercial as-received and purified CNTs were performed at 5° C./min ramp rate from room temperature to 900° C. Nitrogen gas was used to purge the balance chamber during the treatment of the CNTs with dry air. The flow rates of the dry air and the nitrogen gas were set at 10 mL/min and 25 mL/min, respectively.

Raman spectra were collected at room temperature in the backscattering configuration using Renishaw in Via spectrometer equipped with a Peltier cooled RenCam dd-CCD. A Leica DM LM confocal microscope with 100°ø objective was used to illuminate the sample and collect the scattered light. It was set to operate at ˜1 μm diameter focal spot size at the plane of the sample. A HeNe laser was used to excite the spectra, and the power at the sample was ˜0.1 mW measured using a miniature hand-held radiometer. The spectra were collected in air under ambient conditions using 514 nm wavelength laser. Both H and V polarized light were accepted in the scattered radiation.

The specific surface area (SSA) of the as-received CNTs and fabricated CNT membranes were determined using the BET equation with N₂ gas at 77 K (Micrometrics ASAP 2020). The samples were degassed at 300° C. under high vacuum (P≈10⁻⁷ Torr) for 12 hours prior to measurements. The pore volume and the pore size distribution were computed using the Barrett-Joyner-Holenda (BJH) model. Total pore volume was estimated at 95% of the saturation pressure.

A scanning white-light interferometry instrument, the Zygo NV7300 Profilometer, was used to analyze the thickness of the CNT membranes. The instrument consisted of an interferometric objective lens mounted on a piezo scanning device that translates in the vertical direction. The camera positioned at the top of the device detected interferogram intensities of the sample that were sorted with an interfaced computer to store only the high modulating (>5%) data as a three dimensional interferogram. This was then coupled with a frequency domain analysis that determined the heights of each display pixel to a resolution of <0.1 nm and a repeatability of <0.3 nm.

The morphology and the chemical composition analysis with EDS of the membranes were collected in high vacuum using an FEI Nano SEM-630. This scope used a high resolution field emission source and column, along with a monopole magnetic field immersion final lens allowing for extremely high spatial resolution (up to 1 nm) and exceptional contrast. The SEM images were collected using the beam deceleration technique with the stage bias ranging from 1 keV to 2.5 keV, allowing for landing energies in the range of 550 eV to 2 keV, and incoming electron voltage of 1.5 keV to 4 keV.

Electrodes were prepared by punching out a circular disc with an area of ˜1.64 cm², and a mass of ˜0.3 mg measured using a Sartorius microbalance. A 500 Å thin film of gold was sputtered onto one side of the electrodes to reduce interfacial contact resistance between the electrodes and current collectors. Gold foil was used as the current collector for both electrodes. Prior to the assembly of the cell, the electrodes were soaked in aqueous electrolyte for 30 minutes. A PVA membrane was also soaked in the aqueous electrolyte for 24 hours prior to the assembly. Two-electrode symmetric capacitors were assembled by sandwiching the current collectors, electrodes and the separator.

Two-electrode electrochemical capacitor characterization was performed using a Gantry Reference 3000 potentiostat/galvanostat. The cell was tested using cyclic voltammetry (CV), electrochemical impedance spectroscopy (EIS), and constant current charge/discharge cycling. Cyclic voltammetry was performed using a scan range of 0 to 1 V at scan rates of 10, 50, 250, 500, 750, and 1000 mV/s. EIS measurements were performed with an AC perturbation of 10 mV at open circuit conditions. The frequency of the AC perturbation was varied from 10⁵ Hz to 10⁻³ Hz. The equivalent series resistance of the cell was computed using the impedance data measured at 1 kHz. Galvanostatic charge/discharge cycling was performed by applying a load current density (based on the mass of both electrodes) ranging from 1 A/g to 50 A/g for 10,000 cycles.

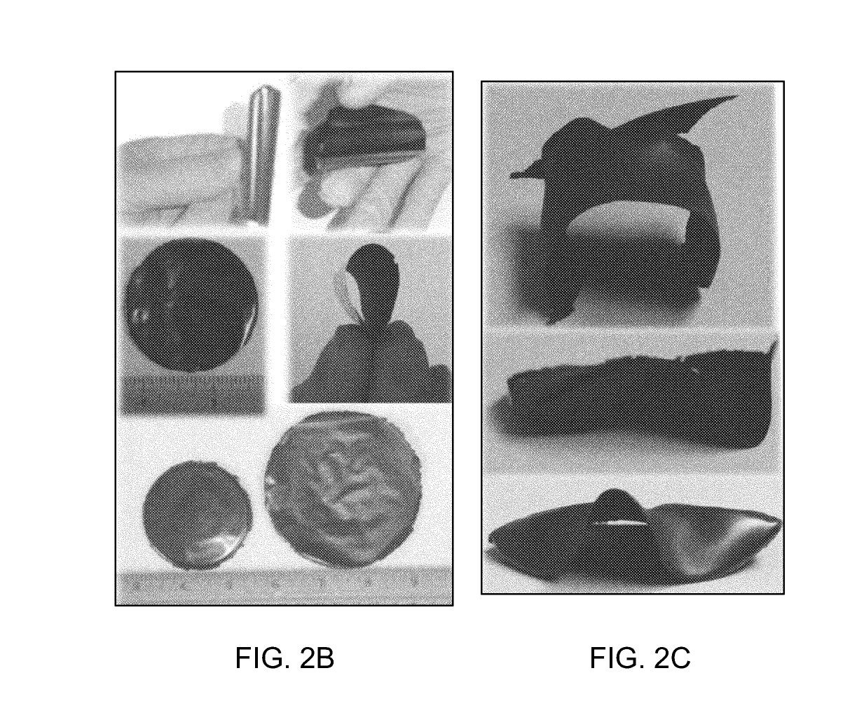

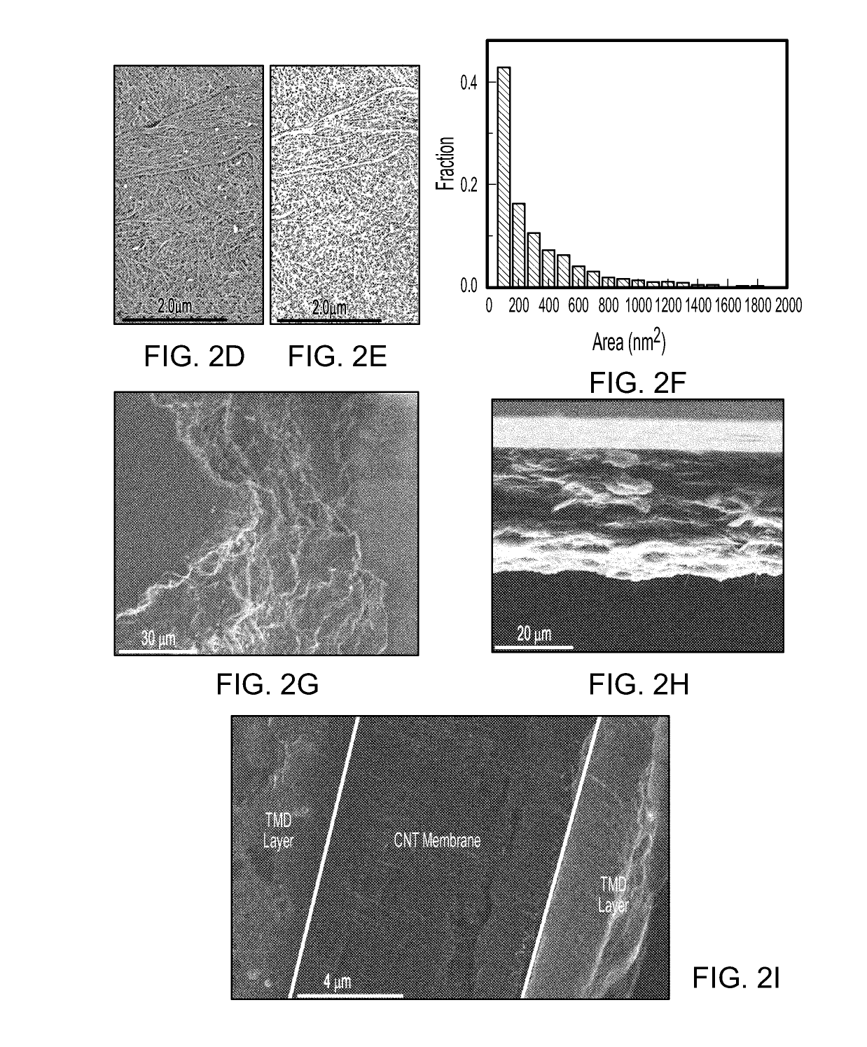

FIG. 2A shows images of some of the prepared membranes. The upper left image in FIG. 2A shows a membrane prepared from a mixture of carbon nanotubes and carbon nanofibers (“CNTs+CNFs”). The lower left image in FIG. 2A shows a membrane prepared from a mixture of carbon nanotubes and carbon nanoparticles (“CNTs+CNPs”). The upper right and lower right images in FIG. 2A show a membrane prepared from carbon nanotubes (“CNTs”). In particular, the membrane shown in the upper and lower right images in FIG. 2A was prepared from single-walled CNT powder obtained from Thomas Swan & Co., Consett, UK, and suspended in liquid bromine. After removal of the bromine and heating in a He—H₂ environment to remove residual impurities, membranes that were several inches in diameter and sufficiently robust to survive direct human handling were obtained.

Shown in FIGS. 2B and 2C are optical images of additional densely packed binder-free CNT membranes, all fabricated under the same conditions using the methods disclosed herein. The CNT membranes in FIG. 2B are thin, smooth, flexible and robust, whereas the CNT membranes in FIG. 2C are buckled and brittle, even though the process of assembly is similar to that of CNT membranes in FIG. 2B.

FIG. 2D shows an SEM image of the surface morphology of a CNT-based membrane. It reveals densely packed and randomly oriented CNTs in the in-plane direction of the membrane. This random interwoven structure of the CNTs is responsible for the robustness and flexibility of the thinner CNT membranes (e.g., FIG. 2B) and the ability to assemble into macro-size structures without the use of binders. FIG. 2E shows an image of the membrane of FIG. 2D filtered into a black-white mode for clear identification of voids on the image using threshold adjustment of the image analysis software. The black regions correspond to the voids in the original image (e.g., FIG. 2D). The statistical distribution of the voids was analyzed using image analysis software, and is shown in FIG. 2F. The total area of the voids was estimated to be ˜16%.

FIG. 2G shows an SEM image of a broken edge of a CNT membrane that reveals densely packed and stacked layers in the CNT membrane. FIG. 2H is a cross-sectional SEM image of a piece of a CNT membrane of length ˜32 μm. FIG. 2I shows a membrane of thickness ˜8 μm sandwiched between layers of transition metal dichalcogenide (TMD) materials. The thicknesses of the CNT membranes in FIGS. 2G-2I was measured with a non-destructive and non-contact optical profilometer (Zygo NV7300).

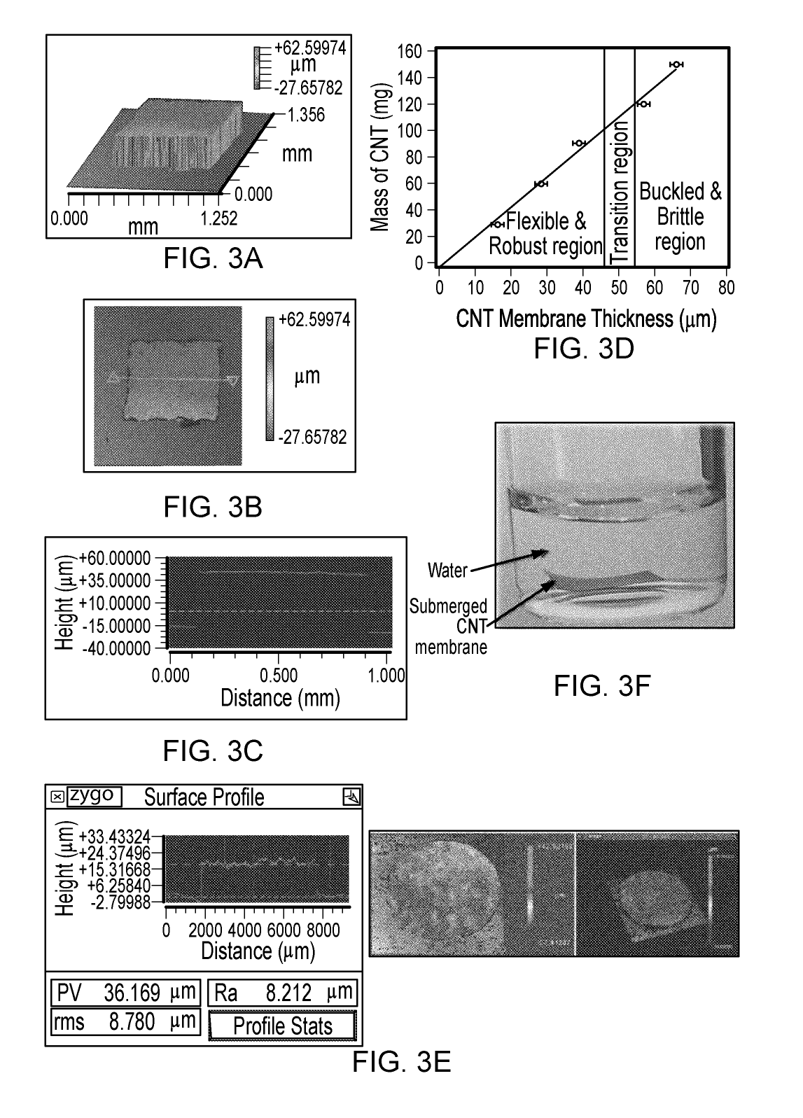

3-D, 2-D and line profiles of a piece of a CNT membrane obtained using the optical profilometer are shown in FIGS. 3A-3C, respectively. FIG. 3D shows a plot of the variation of CNT mass (in mg) versus the CNT membrane thickness (in μm) as determined from the optical profiler measurements for membranes processed under the same conditions, and assembled in the same processing dish (diameter ˜52 mm). The plot (solid dots) in FIG. 3D reveals a linear relationship between the mass of the CNT and the thickness of the CNT membranes. The solid line is the least squares fit of the data with a slope of ˜22.58 g/cm. From the slope, the bulk mass density of the membranes was estimated to be ˜1.11 g/cm³±0.03 g/cm³ using the expression m=ρV=(ρπD²/4)t, where the slope s=ρπD²/4, V is the volume of the membrane, D is the diameter of the membrane (˜ diameter of the processing dish), ρ is the bulk mass density of the membrane, m is the mass of the membrane, and t is the thickness of the membrane.

The membranes were observed to become more brittle as the thickness increased. Membranes with thicknesses t˜≦45 μm appeared to be very flexible, but a gradual transition from highly flexible and robust to buckling and brittleness was observed as the thickness increased. Strong buckling and brittleness occurred in membranes with thicknesses greater than or equal to approximately 55 μm (e.g., FIG. 2C). Without wishing to be bound by theory, it is believed that in the thin membranes, the CNTs are mostly oriented and interwoven in the in-plane direction. However, as the thickness of the membrane increases and approaches the length scales of the CNTs, more and more CNTs are oriented in the out-of-plane direction, which could lead to the buckling and the brittleness.

FIG. 3E shows an optical profilometer image of a 36 micron thick single-walled carbon nanotube membrane. As is evident from FIG. 3E, the thickness of the membrane is highly uniform across the membrane surface. FIG. 3F is an image of a piece of a CNT membrane submerged under water, demonstrating that the density of the membrane is greater than the density of liquid water.

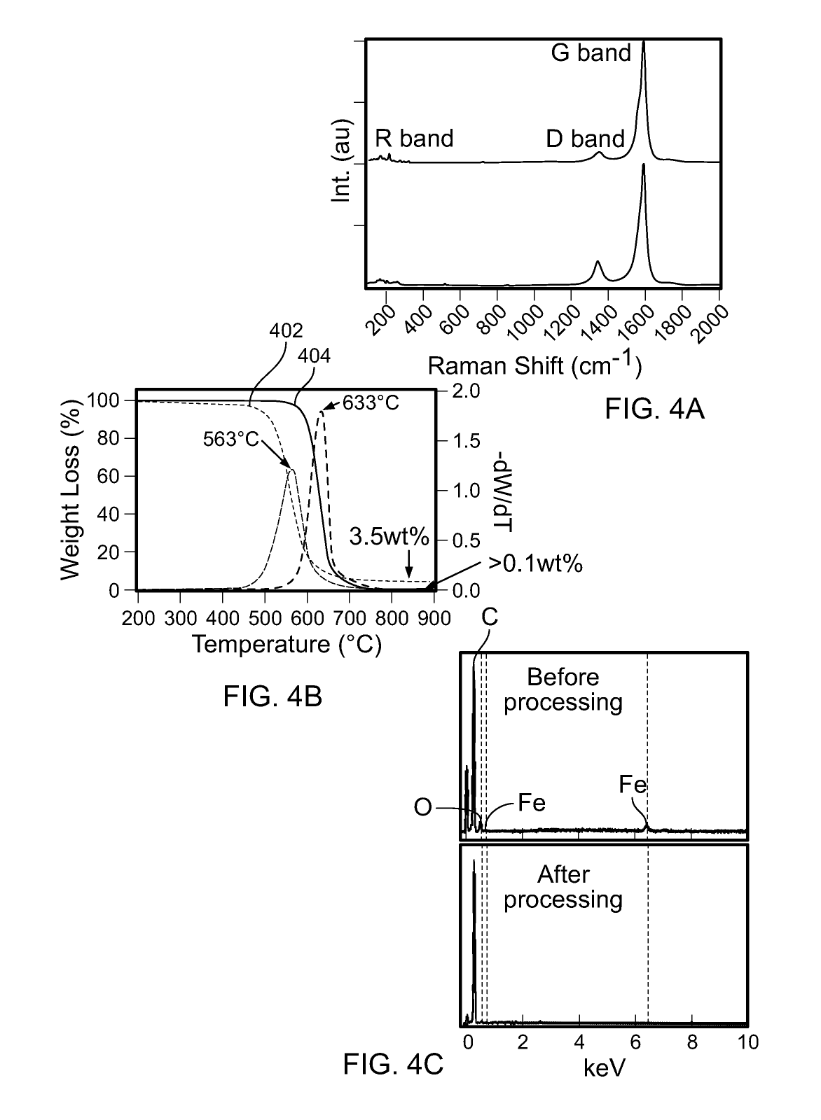

FIG. 4A shows a comparison of Raman spectra of the CNTs in powder form (bottom curve) and after assembly into a membrane (upper curve). The decrease in D band intensity demonstrated an improvement in sample quality, as scattering in the D band is a feature of voids, vacancies, functional groups, and more generally, defects in the CNTs. FIG. 4B shows thermogravimetric analysis measurements, where the residual weight of noncarbonaceous impurities in the membrane decreased from 3.5 wt % (curve 402) to <<0.1 wt % (curve 404) for a combustion temperature increase from 563° C. to 633° C. for the membrane.

FIG. 4C shows EDS spectra of the as-received CNTs and a CNT membrane. The Fe peak is almost non-existent in the spectrum collected from the CNT-based membrane. The removal of the residual contaminants, mainly metal catalysts, is critical to the electrochemical performance of the CNT membranes as electrodes in energy storage and conversion systems.

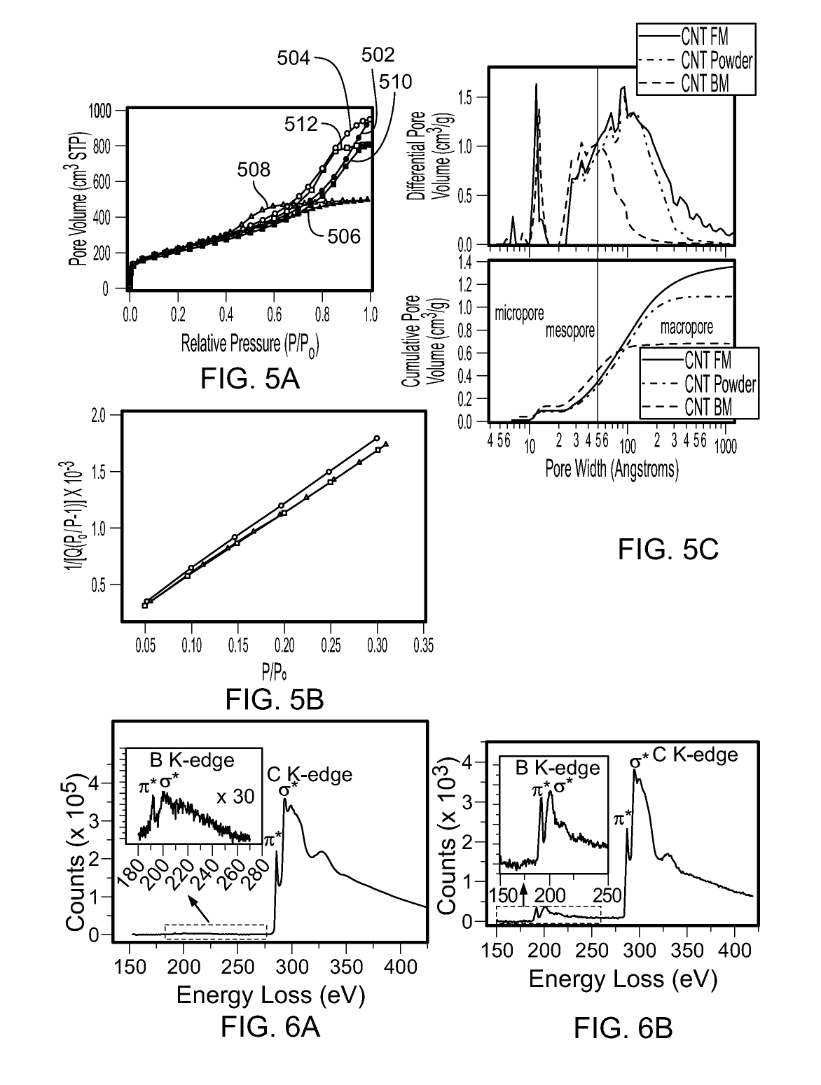

FIG. 5A shows nitrogen adsorption and desorption isotherms for CNT powder and binder-free membranes as a function of relative gas pressure. Curves plotted with solid markers correspond to adsorption isotherms; curves plotted with open markers correspond to desorption isotherms. In FIG. 5A, isotherms are shown for a CNT-FM membrane (adsorption: 502; desorption: 504), a CNT-BM membrane (adsorption: 506; desorption: 508), and CNT powder (adsorption: 510; desorption: 512). There is a hysteresis at high relative pressures in both the membranes and the CNT powder, indicating the presenence of predominantly meso- and macro-pores.

The BET surface areas of the CNT powder, the CNT-BM membrane, and the CNT-FM membrane were 744 m²/g, 798 m²/g and 792 m²/g, respectively, as determined from the BET plot shown in FIG. 5B (CNT-FM membrane: circle markers; CNT-BM membrane: triangular markers; CNT powder: square markers). The relatively small increase from the powder to the membranes may be due mostly to the change of “state” from clusters in powder form to interwoven in membrane. This implies that the fabrication method did not have a significant effect on the CNTs skeletal structure, since only the external surfaces in both the powder and the membranes are accessed. The absence of a significant difference in the measurements of the CNT-FM and CNT-BM BET isotherms demonstrates the consistency and repeatability of the methods disclosed herein.

FIG. 5C shows the deduced cumulative pore volume (top plot) and the differential pore volume (bottom plot) using Density Functional Theory (DFT) adsorption analysis (CNT-FM membrane: solid curve; CNT-BM membrane: dashed curve; CNT powder: dot-dash curve). The CNT powder and CNT-FM membrane show a broad distribution of mesopores (diameters between 20-50 Angstroms), and a large concentration of macropores (diameters larger than 50 Angstroms). The pore size of the CNT-BM membrane in the micropore region shows a slight increase relative to the pore sizes of the CNT powder and the CNT-FM membrane.

FIGS. 5A-5C show that the highly interwoven CNT membranes have micro-, meso- and macropores in them, creating a hierarchical pore structure. This yields a CNT membrane-based electrode for electrochemical capacitors with time constants (˜25 ms) approaching electrolytic capacitors. The CNT membranes can also be used as scaffolds to deposit other materials for use in catalysis, photovoltaic, thermoelectric and many other applications. For example, the CNT-based membranes disclosed herein can be used as current collectors or scaffolds with high chemical stability to deposit redox active materials for both high power battery and supercapacitor applications.

FIGS. 6A and 6B show electron energy loss spectroscopy (EELs) data for boron-doped single-walled carbon nanotubes at different dopant concentrations. The differences in the EELs spectra indicate that significant quantities of dopants can be introduced the CNT structures.

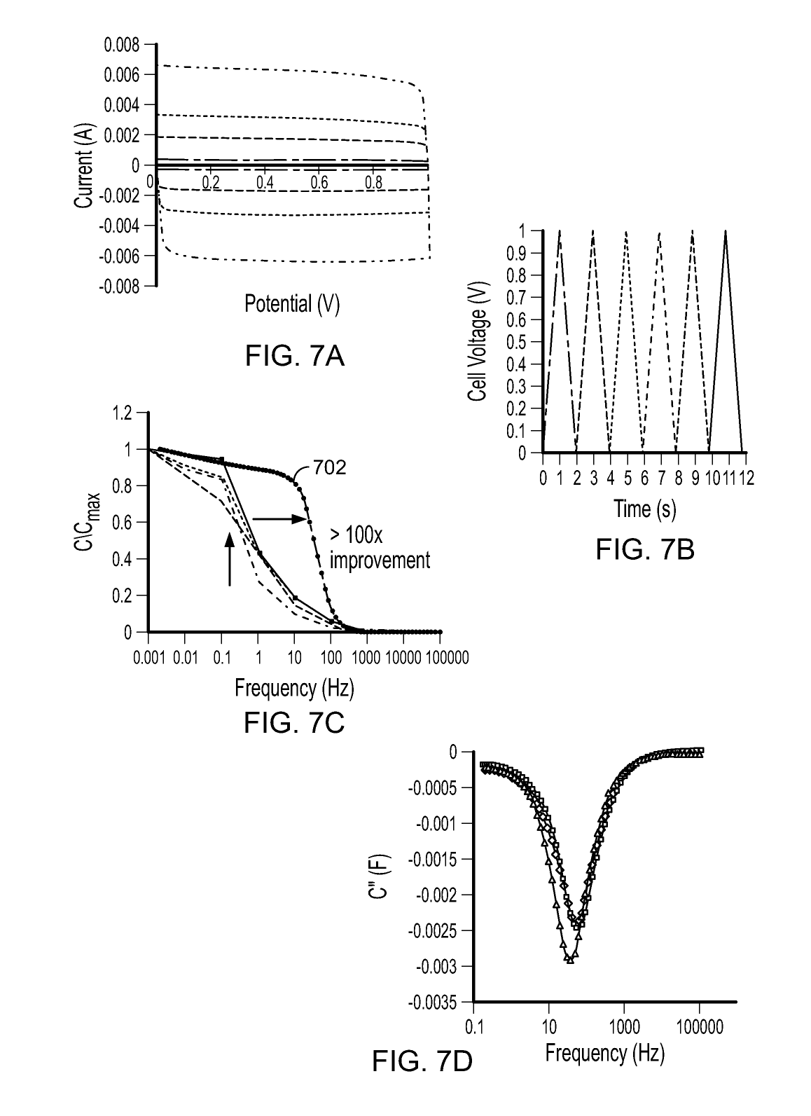

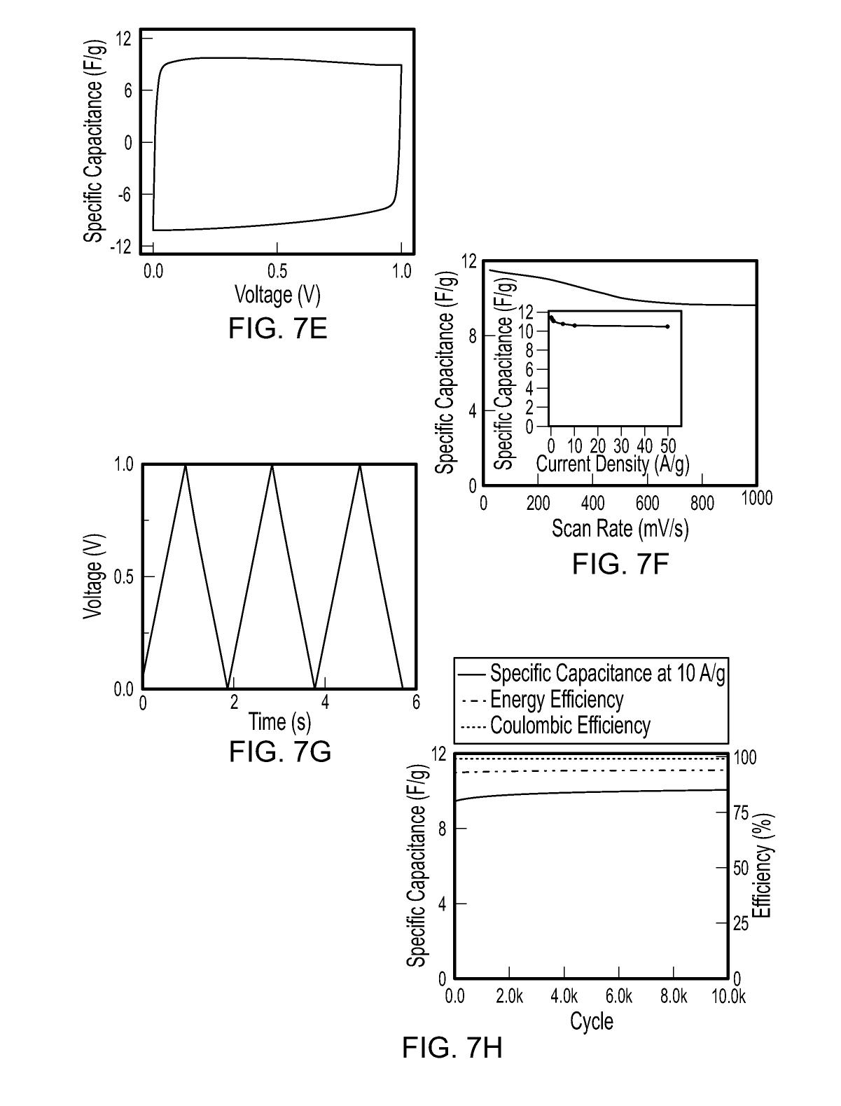

FIG. 7A shows cyclic voltammograms (CVs) measured at different scanning rates for a symmetric aqueous capacitor fabricated with a single-walled CNT-based membrane prepared as disclosed herein, and using a 1 M H₂SO₄ electrolyte solution. The CV curves are nearly rectangular in shape at even the highest scan rate of 1 V/s, indicating that the membrane is capable of very rapid current response upon voltage reversal at each end potential. Further, the straight rectangular shape indicates an equivalent series resistance (ESR) of the electrodes and fast diffusion of electrolyte in the membrane.

FIG. 7B shows charge-discharge response curves for the capacitor of FIG. 7A. The response of the charge process shows a nearly ideal mirror image of the corresponding discharge counterpart with no current-resistance drop, reflecting a small ESR of the electrodes.

FIG. 7C shows a comparison between an impedance curve of a supercapacitor that includes a membrane formed from single-walled CNTs (curve 702) and impedance curves corresponding to other commercial non-aqueous capacitors. Capacitors that include membranes prepared as disclosed herein show a more than 100-fold improvement in frequency response relative to the commercial capacitors.

FIG. 7D shows a comparison between impedance curves for supercapacitors that include a membrane prepared using the methods disclosed herein, with different electrolyte concentrations (diamonds: 3M H₂SO₄; squares: 2M H₂SO₄; triangles: 1M H₂SO₄). It is evident from the impedance curves that the impedance of the capacitors can be reduced systematically by increasing the electrolyte concentration.

FIG. 7E shows a cyclic voltammogram of two electrode capacitor formed from a CNT membrane and a hydrogel separator soaked in 1M aqueous sulfuric acid, cycled at 1 V/s. The voltammogram exhibits a rectangular shape indicating a capacitive response with excellent power capability at 1 V/s. Measurement of cell capacitance at different scan rates showed that the specific capacitance was ˜10 F/g and was nearly invariant with scan rate, as shown in FIG. 7F.

FIG. 7G shows the constant current charge/discharge response of the capacitor cycled at 10 A/g. The curve shows a typical saw-tooth profile. Constant current charge/discharge measurements performed at different current densities indicated that the capacitance does not show any sign of fading even at a very high current density of ˜50 A/g (as shown in the insert to FIG. 7F). The specific capacitance was about 10 F/g, as shown in FIG. 7H, and remained constant over 10,000 cycles. The coulombic efficiency was close to 100% and the energy efficiency of all the samples was ≧94% when cycled at 10 A/g, indicative of very low ohmic drop at such high current densities.

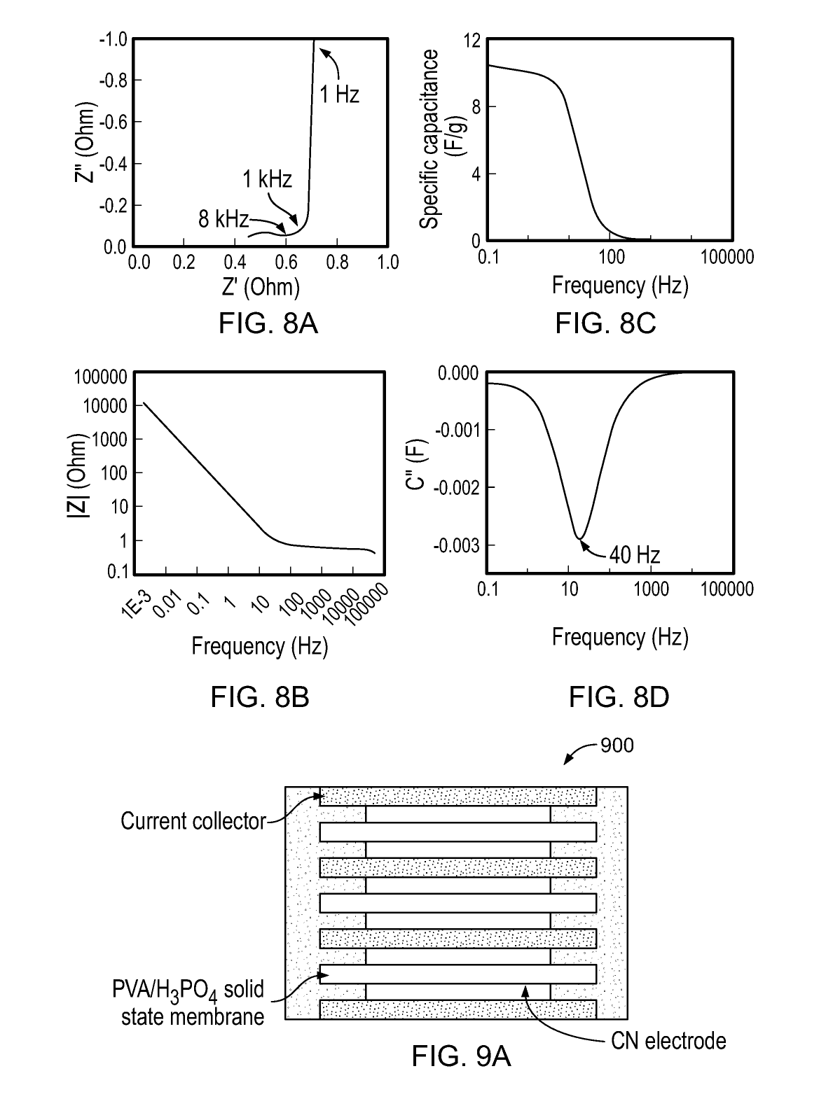

FIGS. 8A and 8B show typical Nyquist and Bode plots, respectively, for the CNT membrane-based capacitors in 1M aqueous sulfuric acid electrolytes. The Nyquist plot shows a semicircle at high frequencies followed by a Warburg behavior indicating a contribution due to ionic diffusion and a vertical line at low frequency showing the capacitive behavior. The knee frequency at which the capacitive contribution ensues was 1 kHz, which is significantly higher than most CNT-based capacitors reported in the literature. Typically, most CNT capacitors show a knee frequency in the range of 100-300 Hz, while conventional capacitors made using activated carbon electrodes typically have knee frequencies lower than 1-10 Hz.

FIG. 8C shows the capacitance as a function of frequency for a CNT membrane-based capacitor in 1M H₂SO₄, and FIG. 8D shows the relaxation frequency of the capacitor, which was approximately 40 Hz (i.e., τ˜25 ms). Such high frequencies can be achieved by designing capacitors using binder-free self-assembled carbon nanotube electrodes containing micro- and mesoporosity and a highly ionic conducting hydrogel membrane as a separator. The maximum power density of the capacitors based on impedance performance was as high as 1040 kW/kg, which is significantly higher than most two electrode CNT-based capacitors reported in the literature.

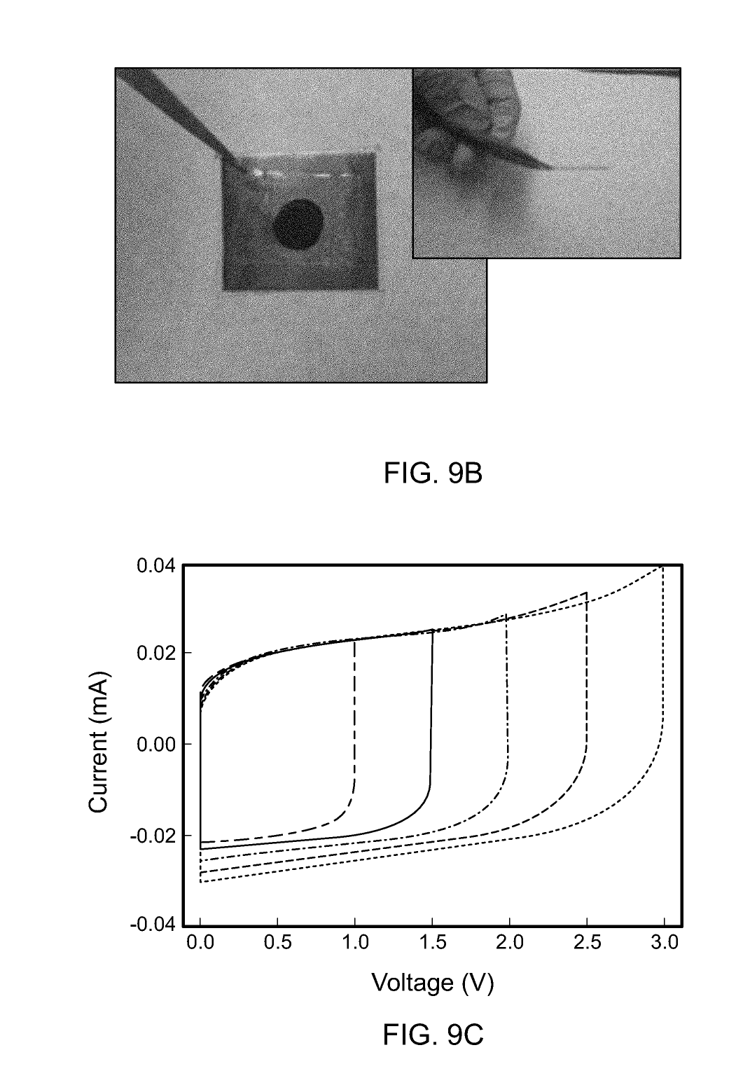

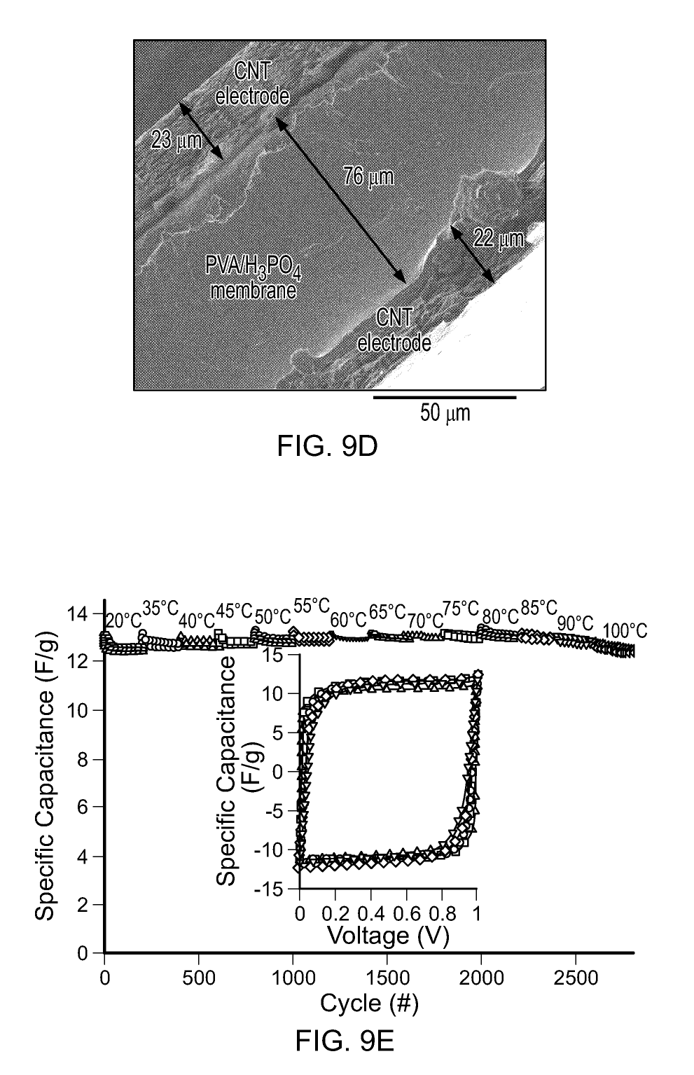

FIG. 9A is a schematic diagram of a multilayer supercapacitor 900 that includes multiple electrodes, each implemented as a CN-based membrane fabricated according to the methods described herein. Also included in supercapacitor 900 are multiple 25 μm thick graphene sheets that function as current collectors, and multiple polyvinylalcohol (PVA)—H₃PO₄ solid state membranes for charge localization. FIG. 9B shows two images of a fabricated supercapacitor having the structure shown schematically in FIG. 9A.

FIG. 9C is a plot showing cyclic voltammograms measured for the supercapacitor of FIG. 9A, for various maximum voltage values. The voltammograms show a highly consistent response of the supercapacitor in each cycle.

FIG. 9D is a cross-sectional SEM image of an all solid-state flexible supercapacitor formed from CNT-based membranes (as the electrodes) and separator layers formed from polyvinyl alcohol (PVA) sheets soaked in H₃PO₄.

FIG. 9E is a plot showing specific capacitance measurements for the supercapacitor of FIG. 9A as a function of temperature. These measurements also show highly consistent behavior, demonstrating that the supercapacitor is stable over a broad range of temperatures from 20° C. to 100° C.

### Other Embodiments

A number of embodiments have been described. Nevertheless, it will be understood that various modifications may be made without departing from the spirit and scope of the disclosure. Accordingly, other embodiments are within the scope of the following claims.

What is claimed is:

1. A method for preparing a carbon nanostructure membrane, the method comprising:
initiating self-assembly of a plurality of carbon nanostructures by suspending the nanostructures in a liquid, wherein the liquid has a density that exceeds a density of the nanostructures;
forming a membrane on a surface by removing the liquid, thereby depositing the nanostructures on the surface; and
heating the membrane in a vessel comprising hydrogen gas.

2. The method of claim 1, wherein the liquid comprises bromine.

3. The method of claim 1, wherein the density of the liquid is between 1.3 g/cm³ and 3.5 g/cm³.

4. The method of claim 1, wherein the liquid has an electron affinity of −100 kJ/mol or more.

5. The method of claim 1, further comprising removing the liquid by heating the liquid.

6. The method of claim 1, wherein the liquid has a boiling point temperature at atmospheric pressure of 244° C. or less.

7. The method of claim 1, wherein the surface is a surface of the vessel.

8. The method of claim 1, wherein the surface is formed of at least one metal selected from the group consisting of platinum, gold, silver, and copper.

9. The method of claim 1, wherein heating the membrane comprises heating the membrane to a temperature of 1000° C. or more.

10. The method of claim 9, wherein heating the membrane comprises heating the membrane to a temperature of 1200° C. or more.

11. The method of claim 1, wherein a concentration of hydrogen gas in the vessel is 1% or more.

12. The method of claim 11, wherein a concentration of hydrogen gas in the vessel is 5% or more.

13. The method of claim 1, further comprising continuing the heating until a concentration of the liquid in the membrane is less than 1000 ppm.

14. A binder-free membrane, comprising:
a plurality of carbon nanostructures arranged to form a substantially planar layer,
wherein an average density of the carbon nanostructures in the membrane is 0.5 g/cm³ or more.

15. The membrane of claim 14, wherein an electrical conductivity of the membrane is 1.0×10⁴ S/m or more.

16. The membrane of claim 14, wherein a Young's modulus of elasticity of the membrane is 0.01 GPa or more.

17. The membrane of claim 14, wherein an in-plane thermal conductivity of the membrane is 250 W/m·K or more and an out-of-plane thermal conductivity of the membrane is 0.5 W/m·K or more.

18. The membrane of claim 14, wherein a contact angle of a water droplet on a surface of the membrane is 175° or less.

19. The membrane of claim 14, wherein the carbon nanostructures comprise at least one dopant.

20. The membrane of claim 19, wherein the at least one dopant comprises a material selected from the group consisting of nitrogen and boron.

21. The membrane of claim 14, wherein the carbon nanostructures comprise at least one metallic material.

22. The membrane of claim 21, wherein the at least one metallic material comprises a material selected from the group consisting of Pt, V, Ti, Ru, Cr, Mn, Mo, Co, Fe, Pd, and Os.

23. The membrane of claim 14, further comprising a support layer on which the membrane is positioned.

24. The membrane of claim 23, wherein the support layer comprises at least one metallic material.

25. The membrane of claim 24, wherein the at least one metallic material is selected from the group consisting of platinum, gold, silver, aluminum, and copper.

26. The membrane of claim 23, wherein the support layer comprises at least one polymer material.

27. The membrane of claim 26, wherein the at least one polymer material is selected from the group consisting of polycarbonates, polypropylenes, polyethylenes, polyvinyls, polyacrylates, polystyrenes, and polymethylmethacrylates.

28. The membrane of claim 14, wherein the carbon nanostructures comprise carbon nanoparticles.

29. The membrane of claim 14, wherein the carbon nanostructures comprise carbon nanofibers.

30. The membrane of claim 14, wherein the carbon nanostructures comprise carbon nanotubes.

31. The membrane of claim 30, wherein the carbon nanotubes comprise single walled carbon nanotubes.

32. The membrane of claim 30, wherein the carbon nanotubes comprise multi-walled carbon nanotubes.

33. The membrane of claim 14, wherein the carbon nanostructures comprise a mixture of carbon nanoparticles and carbon nanotubes.

34. The membrane of claim 14, wherein the carbon nanostructures comprise a mixture of carbon nanofibers and carbon nanotubes.

35. The membrane of claim 14, wherein the carbon nanostructures comprise carbon nanohorns.

36. The membrane of claim 23, wherein the support layer comprises at least one transition metal dichalcogenide material.
